(19) United States
(12) Patent Application Publication
(10) Pub. No.: US 2004/0127279 A1
(43) Pub. Date: Jul. 1, 2004

(54) Methods, systems and email content enabling email recipients to win prizes

(76) Inventors: Jean-Marie Gatto, London (GB); Thierry Brunet De Courssou, Palo Alto, CA (US)

Correspondence Address: Alan W Young, Young Law Firm, A Professional Corporation, 4370 Alpine Road Suite 106, Portola Valley, CA, 94028, US

(21) Appl. No.: 10/332,475

(22) PCT Filed: Jul. 20, 2001
(86) PCT No.: PCT/US01/23313

(51) Int. Cl. A63F 13/00

(52) U.S. Cl. 463/17; 463/42

(57) ABSTRACT

Email tickets (100) that enable the email recipients to win prizes. The method comprises the preparation process, the dispatch process, the electronic scratching to reveal the secret symbols and the prize claiming process. A ticket according to the present invention comprises principally two layers: the promotional layer (S131) and the secret layer (S132). The promotional layer and the secret layer are combined (S133) in an email ticket (S134) in such a way that the promotional layer is shown first, and then the secret symbols are revealed following some exciting interactive operations or a predetermined timeout.

### BACKGROUND OF THE INVENTION

1. Field of the Invention

The invention pertains to the field of electronic gaming.

2. Description of the Related Art

Traditional lottery organizations earn significant revenues from the selling of email tickets, in which a specially formulated latex layer hides a set of secret symbols printed on a small piece of cardboard. The player then scratches the latex layer to reveal the hidden symbols. Predetermined sets of symbols correspond to winning prizes. Extreme security is applied in the formulation of paper, ink and latex, in the preparation process, in the distribution process and in the prize claiming process to avoid fraud.

The recent popularization of the Internet has given rise to a widespread proliferation of electronic games played on PCs (personal computers) via a standard World Wide Web (hereafter “Web”) browser and Internet connection. There are now numerous sites on the Web offering casino and lottery games. Not surprisingly, Internet gaming has met with significant success. Free gaming on the Web has proved to be especially popular, such that offered at www.FreeLotto.com. At FreeLotto.com, players need not pay or wager to enter a drawing or play, but are instead exposed to advertising in return for entering the drawing, playing the game or winning prizes. Web browser based email tickets may be played on Web sites such as www.prizes.com and www.realtimemedia.com. Depending on the game provider's business model, the pool of money from which prizes are paid is supplied either by direct payments from players and/or from advertisers, promoters or sponsors.

With attractive static or polished animated graphics, email ticket games can help build a strong connection between a target audience and promotion objectives. Scratch-off tickets, both on the Web and on paper, actively involve the players and offer instant gratification. Excitement builds as players expose hidden images and reveal winnings. On the Web, hyperlinks may be used to automatically draw a potential player to a promotional Web page. This process multiplies the effect of a promotion and can help achieve the stated objectives thereof better and faster than any other type of promotion.

Web browser-based gaming requires players to take the initiative to establish a connection with the web site that offers the game. Very quickly, however, the novelty of such gaming Web sites wears thin. Typically, as the initial excitement passes, the number of repeat visits to such sites decreases significantly.

### SUMMARY OF THE INVENTION

The present invention offers another dimension in the Internet gaming whereby players can receive an electronic counterpart of traditional scratch paper tickets via email and win prices without having to make the effort of connecting to a Web site to play. According to the present invention, an email ticket includes at least a promotional layer and a secret layer. The promotional layer is that which is seen by the player on his or her screen before the secret symbol sets are revealed. The secret layer may advantageously be smaller than the promotional layer and may be revealed at some place under the promotional layer. The promotional layer and the secret layer are combined in an email ticket such that the promotional layer is shown first, and then the secret symbols are revealed after some interaction with the email recipient player and/or a predetermined time-out.

The present invention is drawn to such email tickets, as well as methods for making the email tickets, sending the email tickets and validating the authenticity of any potentially winning ticket presented for payment by a prize claimant. The present email tickets enable players to interactively reveal set of initially hidden symbols. When the revealed symbol set matches one of a predetermined number of winning symbol sets, the player may claim prizes, such as cash, credit, points, goods, discounts coupons, free travel, etc. The present method includes a secure email ticket preparation process that avoids fraud prior to the distribution process, a secure distribution process that avoids fraud during the dispatch process, and a secure validation and claiming process that avoids fraud by fraudulent players. The present methods include several processes that may all be implemented by the same business or commercial organization, or that may advantageously be outsourced piecewise to various service providers.

According to an embodiment thereof, the present invention is an email ticket that provides an email ticket recipient an opportunity to win a prize, comprising a secret layer, the secret layer being configured to be initially hidden from view and gradually revealed following a predetermined action by the email recipient, the secret layer including a representation of a symbol set, the symbol set including one of a plurality of combinations of selected symbols, and a promotional layer, the promotional layer being configured to initially obscure the secret layer and to progressively reveal at least a portion of the secret layer following the predetermined action by the email recipient, at least one of the secret layer, the email ticket and the promotional layer including authentication information that enables authentication of a potentially winning email ticket.

The authentication information may be graphically rendered on the secret layer, the promotional layer or the email ticket. The authentication information may be human readable and may be displayed at a predetermined location on the email ticket. The authentication information may be displayed on the email ticket initially, progressively or following the predetermined action by the email recipient. The authentication information may be (at least initially) encrypted or scrambled. The authentication information may be visible or human readable only after having been decrypted or descrambled using secure means. The authentication information may include a secret layer serial number uniquely identifying the secret layer. The secret layer may be associated with a secret layer sequence number, the secret layer sequence number denoting a sequential position of the secret layer within a batch of secret layers after the order of constituent secret layers of the batch has been randomized (shuffled).

The authentication information may be rendered as a bitmap graphic. The authentication information may include color, for example, and/or other attributes. The representation of the symbol set may be rendered as a bitmap graphic. The secret layer may be non-rectangular in shape. The promotional layer may overlie the secret layer and may have a shape that matches the shape of the secret layer. The promotional layer may be shaped as and/or include a corporate logo, for example.

The promotional layer may include a hyperlink. The hyperlink may be an Internet hyperlink configured to enable the email recipient to download and install software. Alternatively, the hyperlink may be a hyperlink to an Internet page that may be activated by the email recipient or the hyperlink may be configured to enable the email recipient to automatically generate an email to obtain further information, for example.

The promotional layer and/or the secret layer may be configured as a puzzle. The secret layer may be configured as a puzzle and the representation of the symbol set may be unintelligible until the puzzle may be solved. The puzzle may include a jigsaw puzzle and/or a sliding block puzzle, for example.

The email ticket may be configured to cause a sound effect to be selectively played. The sound effect may include music and/or a human voice announcement. The human voice may explicitly inform the email recipient that he or she has won a prize (or has not won a prize). The sound effect may include a scratching sound. The predetermined action may include a twirling action of a pointing device and the email ticket may be configured to swirl away to progressively reveal at least a portion of the secret layer. The promotional layer may be configured to reveal at least a portion of the secret layer after a predetermined timeout when the email ticket recipient does not carry out the predetermined action.

The email ticket may be configured to generate a scrambled audio message, and the email ticket may be further configured to progressively transform the scrambled audio message into a clear intelligible audio message during the predetermined action by the email ticket recipient. The email ticket may be configured to generate a scrambled audio message, and the email ticket may be further configured to progressively replace the scrambled audio message with a clear intelligible audio message during the predetermined action by the email ticket recipient. The email ticket may be configured to generate a scrambled audio message and a visual message and the email ticket may be further configured to progressively replace the scrambled audio message with or transform the scrambled audio message into a clear intelligible audio message and to progressively reveal the visual message during the predetermined action by the email ticket recipient.

The graphically rendered authentication information may be configured as a bitmap resulting from a bitmap compression of a bitmap rendering of the symbol set. The graphically rendered authentication information may be configured as a bitmap resulting from a bitmap compression of a bitmap rendering of the symbol set and of a bitmap rendering of a serial number of the secret layer. The graphically rendered authentication information may be configured as a bitmap resulting from a bitmap compression of a bitmap rendering of the symbol set, of a bitmap rendering of a serial number of the secret layer and of a bitmap rendering of a random pattern. The graphically rendered authentication information may be configured as a bitmap resulting from a bitmap compression of a bitmap rendering of a serial number of the secret layer. The graphically rendered authentication information may be configured as a bitmap resulting from a JPEG compression of the bitmap rendering of the representation of the symbol set. The graphically rendered authentication information may be configured as a bitmap resulting from a JPEG compression of the bitmap rendering of the representation of the symbol set and of a bitmap rendering of a serial number of the secret layer. The graphically rendered authentication information may be configured as a bitmap resulting from a JPEG compression of a bitmap rendering of a serial number of the secret layer. The graphically rendered authentication information may be configured as a bitmap resulting from a JPEG compression of a merging of a bitmap rendering of the representation of the symbol set, of a bitmap rendering of a serial number and of a bitmap rendering of a random pattern. The graphically rendered authentication information may be configured as a bitmap results from an encryption of a bitmap rendering of the representation of the symbol set. The graphically rendered authentication information may be configured as a bitmap resulting from an encryption of a merging of a bitmap rendering of the representation of the symbol set and of a bitmap rendering of a serial number. The graphically rendered authentication information may be configured as a bitmap resulting from an encryption of a merging of a bitmap rendering of the representation of the symbol set, of a bitmap rendering of a serial number and of a bitmap rendering of a random pattern.

The email ticket may be digitally signed by a certified authority. The authentication information may include a readable verification code displayed in one of plain text and as a bitmap.

According to another embodiment thereof, the present invention is a computer system configured to distribute a batch of email tickets that provide email ticket recipients an opportunity to win a prize, comprising at least one processor and a plurality of processes spawned by the processor(s), the processes including processing logic for sending a batch of email tickets to selected email ticket recipients, each email ticket of the batch including a secret layer, the secret layer being configured to be initially hidden from view and gradually revealed following a predetermined action by the email recipient, the secret layer including a representation of a symbol set, the symbol set including one of a plurality of combinations of selected symbols, and a promotional layer, the promotional layer being configured to initially obscure the secret layer and to progressively reveal at least a portion of the secret layer following the predetermined user action, at least one of the secret layer and the promotional layer including human readable authentication information that enables secure authentication of a potentially winning email ticket.

The selected email recipients may be stored in a database accessible to the computer system. The computer system may be coupled to a network accessible to potential players and the computer system may be further configured to enable the potential players to register to receive the email tickets over the network. The network may include the Internet.

### BRIEF DESCRIPTION OF THE DRAWINGS

FIG. 1 is a view of an email ticket as rendered on a browser or email client, in which the secret layer is concealed by the promotional layer, according to an embodiment of the present invention.

FIG. 2 is a view of an email ticket as rendered on a browser or email client, in which the secret layer has been revealed, according to an embodiment of the present invention.

FIG. 3 is a detail view of a secret layer of an email ticket revealing prize amounts, according to an embodiment of the present invention.

FIG. 4 is a detail view of a secret layer of an email ticket revealing symbols, according to an embodiment of the present invention.

FIG. 5 is a detail view of the promotional layer of the email ticket of FIG. 1, according to an embodiment of the present invention.

FIG. 6 is a detail view of a partially scratched off promotional layer of an email ticket according to an embodiment of the present invention, revealing a portion of the underlying secret while producing simultaneous scratching sound effects.

FIG. 7 is a detail view of an email ticket according to an embodiment of the present invention, in which the secret layer has been revealed and an audible voice announces the player's winnings.

FIG. 8 is a detail view of an email ticket according to an embodiment of the present invention, in which the secret layer is revealed by a twirling action of the player's mouse or pointing device.

FIG. 9 is a detail view of another embodiment of an email ticket according to the present invention, in which the player is invited to “twist” the bottle cap off to download a screensaver.

FIG. 10 is a diagram of an email ticket according to still another embodiment of the present invention, in which the player is invited to click on and twirl a bottle cap to reveal his or her winning initially concealed under a secret layer on the bottle cap, with accompanying animation and sound effects.

FIG. 11 is a diagram of a secret layer of an email ticket according to an embodiment of the present invention, with a sliding block puzzle and sound effects.

FIG. 12 is a diagram of a secret layer of an email ticket according to another embodiment of the present invention, with a jigsaw puzzle and sound effects.

FIG. 13 is a flow chart illustrating the present method for making email tickets according to the present invention.

FIG. 14 is a flow chart illustrating steps that may be carried out to by an email ticket supplier to generate the secret layers of the email tickets, according to an embodiment of the present invention.

FIG. 15 is a diagram showing a Secret Layer Sequence Number (or some other authentication information) rendered as a matrix of pixels in a rectangular bitmapped graphic, according to an embodiment of the present invention.

FIG. 16 shows steps that may be taken by an email ticket distributor to send the email tickets to the intended email ticket recipients, according to an embodiment of the present invention.

FIG. 17 shows steps that may be taken by an email ticket validator to validate the authenticity of potentially winning email tickets presented by prize claimants.

### DETAILED DESCRIPTION OF THE INVENTION

The email tickets according to the present invention may be prepared individually on the fly or by batch, in accordance with a predetermined prize matrix that specifies the correlation between combinations of secret symbols (symbol sets) and corresponding winning prizes. An example of a prize matrix is shown in table 1 below:

TABLE 1

| Symbol Set | Number of Tickets | Prize (US$) |
|---|---|---|
| 3 Eagles | 1 | 1,000,000 |
| 3 Tigers | 2 | 100,000 |
| 3 Lions | 10 | 10,000 |
| 3 Wolves | 100 | 1,000 |
| 3 Horses | 1000 | 100 |
| 3 Monkeys | 10,000 | 10 |
| Other symbols | 1,000,000 | 0 |

The prize matrix, therefore, defines the symbol sets, the number of email tickets bearing each such symbol set and the prize (if any) associated with each symbol set. The prize need not be monetary, but may include anything of value.

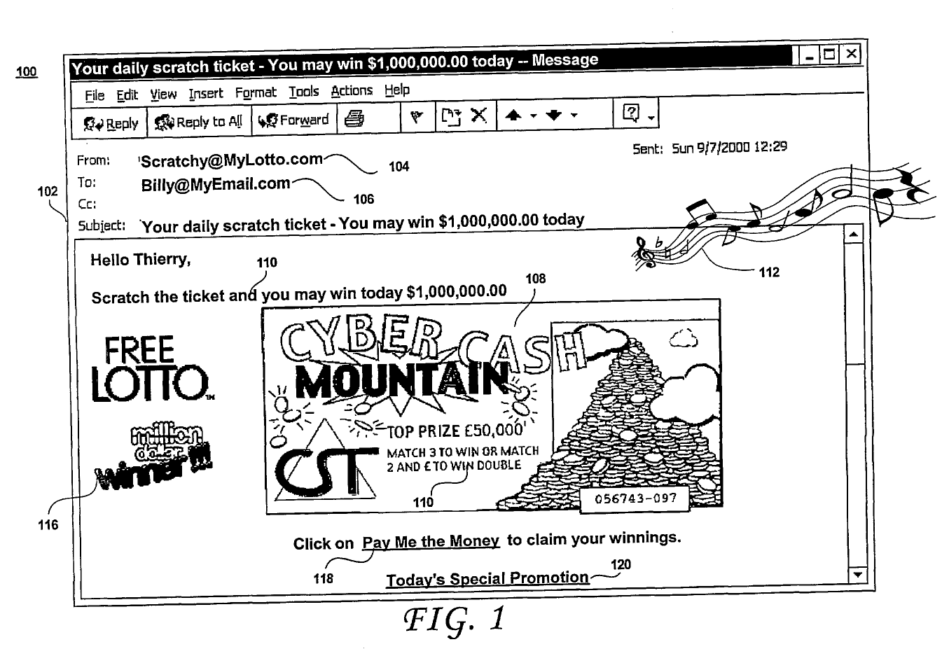

FIG. 1 is a view of an email ticket 100 sent by a game provider 104 to a player (whose email address is shown at 106) as rendered on a browser or email client 102, in which the secret layer is concealed by the promotional layer 108, according to an embodiment of the present invention. The promotional layer 108 is the layer that is seen by the player 106 (the email ticket recipient) on his or her computer screen (or the screen of his or her computing device, mobile device, personal digital assistant, etc.) before the secret symbols are revealed. The promotional layer 108 may have the shape of a rectangle, a polygon, a circle or any predetermined shape. The promotional layer 108 may incorporate plain text such as instructions 110, static graphics and/or animated interactive graphics and/or sound effects and music 112 (that may, for example, be played as soon as the email ticket is opened by the player or at some later point in the player interaction) that attract the player's attention. The email ticket 100 may also include one or more hyperlinks to, for example, an advertising company 114, a promotion company 116, a hyperlink 118 pointing to a site at which the player may claim his or her winnings and/or a hyperlink 120 pointing to a special promotional site.

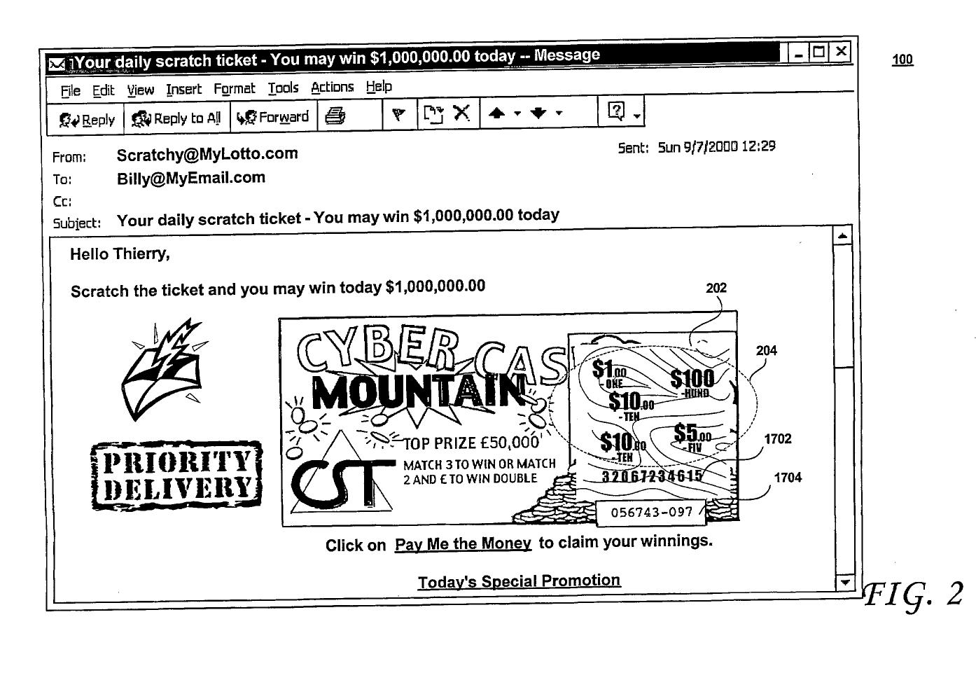

FIG. 2 is a view of an email ticket 100 as rendered on a browser or email client, in which the secret layer 202 has been revealed following some action by the player and/or some predetermined timeout, according to an embodiment of the present invention. The secret layer 202 may have any shape and may incorporate plain text, static graphics and/or animated interactive graphics that reveals a combination of secret symbols (a symbol set 204), which combination is correlated with the prize matrix.

The secret layer 202 is preferably smaller than the promotional layer 108 and may be revealed after the promotional layer 108 is “scratched off” or otherwise altered by the player to progressively or instantaneously reveal the underlying secret layer 202. Special effect and graphic artists or programmers may find other interesting ways to reveal the symbol set 204 of the secret layer 202 on the player's display, depending on the display capability of the player's computing device, mobile device and the like.

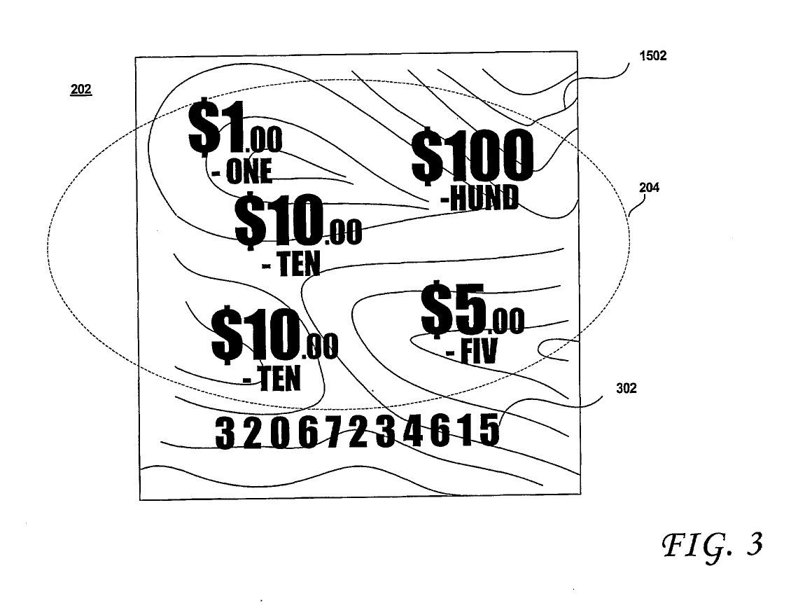

FIG. 3 is a detail view of a secret layer 202 of an email ticket 100 revealing prize amounts, according to an embodiment of the present invention. According to this embodiment, the symbol set 204 includes a combination of symbols representing prize amounts in numerals and letters. Of course, the symbols of the symbol set 204 may refer to any local currency and/or prize amounts, the present invention not being limited to the embodiment of FIG. 3. As shown, the symbol set 204 may be set against a bitmapped (for example) random and unobtrusive background referenced by numeral 1502. The secret layer 202 may also reveal a Secret Layer Serial Number 302 or other authentication information as set out in detail below.

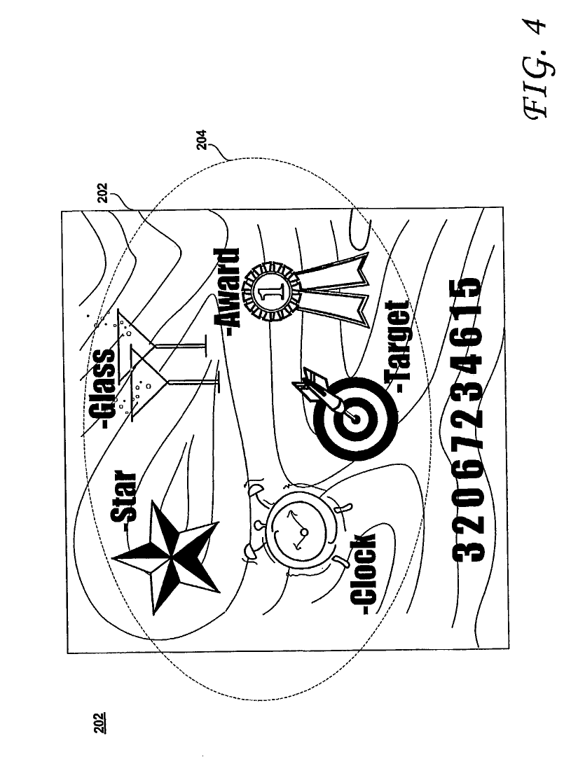

FIG. 4 is a detail view of a secret layer 202 of an email ticket 100 revealing other symbols, according to another embodiment of the present invention. Indeed, the secret layer 202 of the present email tickets may reveal any symbols (in exemplary FIG. 4, a glass, a star, an award, a clock and a target) in any combination, as long as the symbol set 204 conforms to the distribution of winning symbols set forth in the prize matrix for the current batch of email tickets.

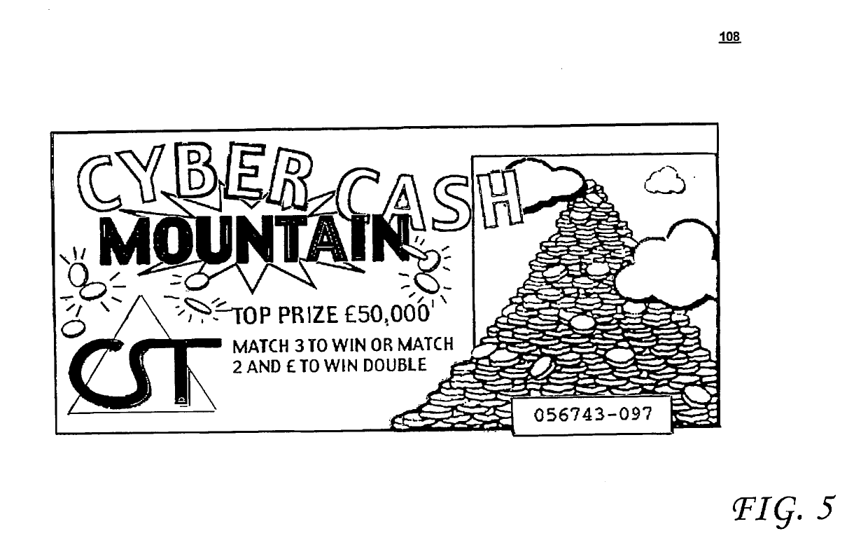

FIG. 5 is a detail view of the promotional layer 108 of the email ticket 100 of FIG. 1, according to an embodiment of the present invention. Any graphic design may be used for the promotional layer, the present invention not being limited to the embodiments shown herein. The promotional layer 108 may advantageously be identical within a batch of email tickets and may, therefore, require only a single design. However, in the case of a personalized campaign, the promotional layer 108 may be chosen from a set of prepared graphics options according to the player profile or any other scheme or criteria, and then combined with the secret layer 202 accordingly.

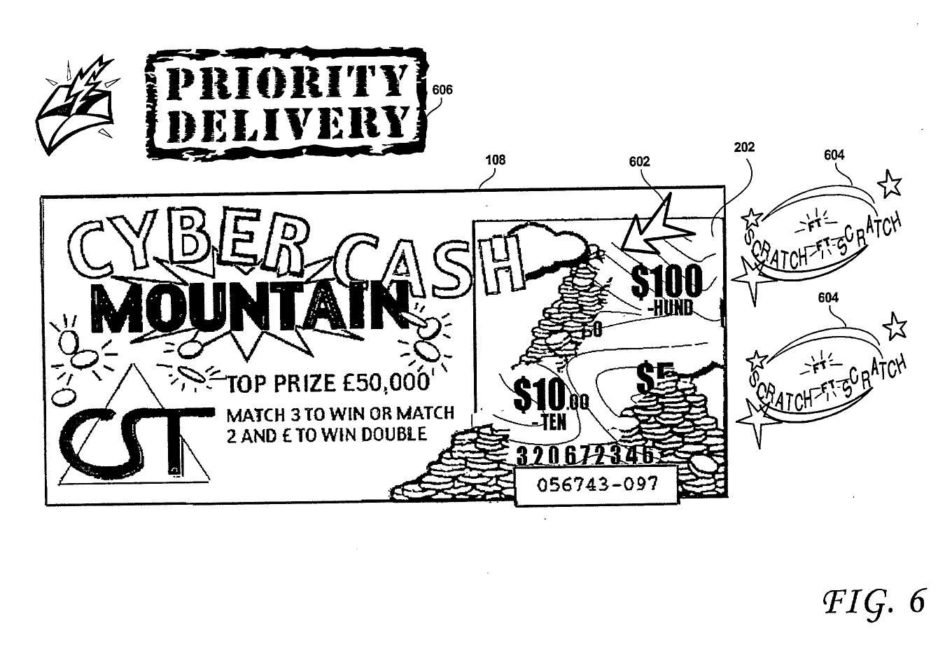

FIG. 6 is a detail view of a partially scratched off promotional layer 108 of an email ticket 100 according to an embodiment of the present invention, revealing a portion of the underlying secret layer 202 while producing simultaneous scratching sound effects 604. The secret layer 202 is only partially exposed through the promotional layer 108. The player, according to the present invention, carries out some predetermined action to progressively or instantaneously reveal the secret layer 202 underlying the promotional layer 108. In the case of FIG. 6, this predetermined action includes moving a cursor 602 over at least a portion of the promotional layer 108 by means of a pointing device, such as a mouse or a trackball, for example. Simultaneously, sound effects 604 may be produced to, for example, simulate a scratching sound one would hear upon revealing symbols underlying a latex layer on a paper and cardboard scratch instant lottery ticket. Upon the player carrying out the predetermined action, additional graphics and/or sensory effects may be rendered on the player's display and system, such as shown at 606.

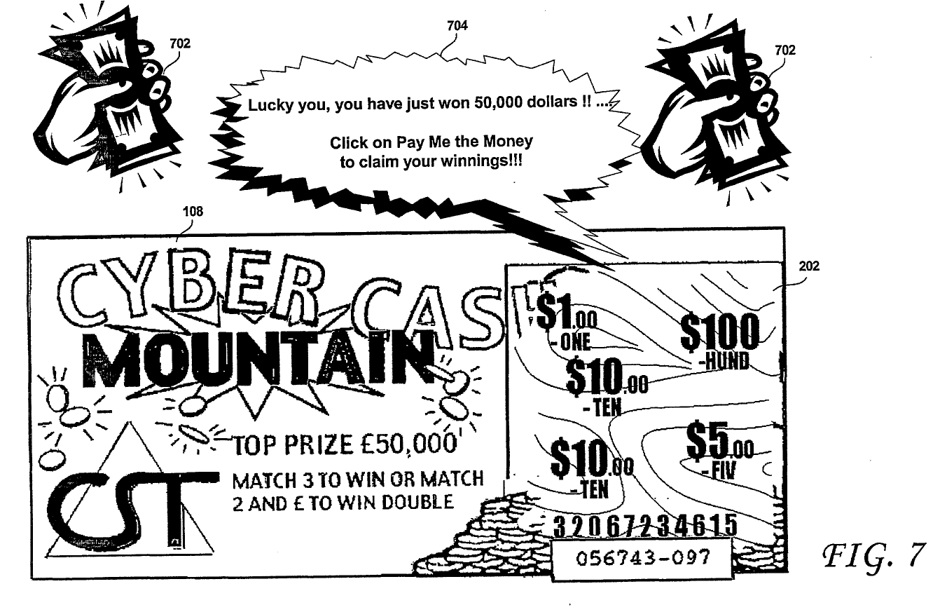

FIG. 7 is a detail view of an email ticket 100 according to an embodiment of the present invention, in which the secret layer 202 has been revealed and an audible voice 704 announces the player's winnings. According to a still further embodiment of the present invention, upon exposing the secret layer 202, an audible voice 704 may announce the player's winnings or may announce that this email ticket is not a winning one. An exemplary winning announcement is shown at 704 in FIG. 7. The announcement 704 may be accompanied by an appropriate graphic, such as one or more blinking icons 702 and/or sound effects, for example.

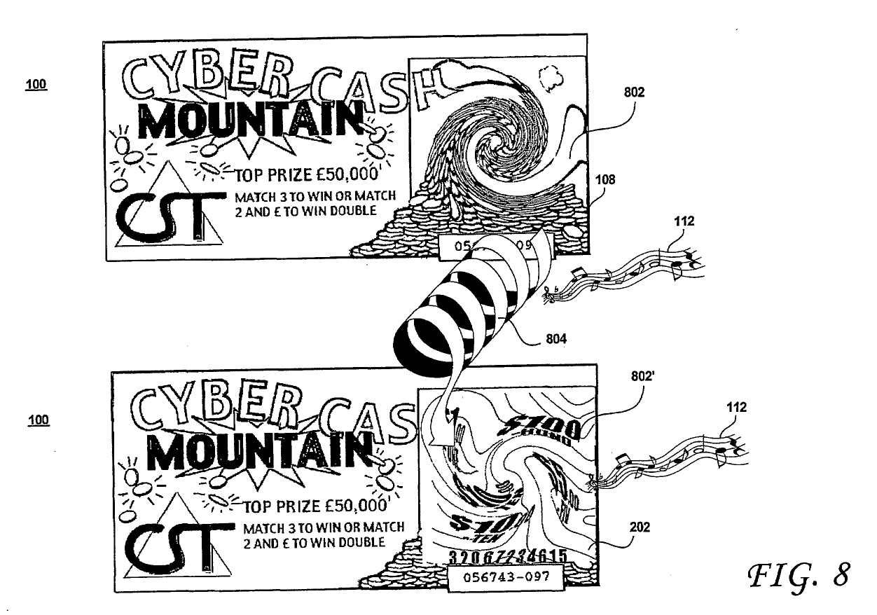

FIG. 8 is a detail view of an email ticket 100 according to an embodiment of the present invention, in which the secret layer 202 is revealed by a twirling action of the player's mouse or pointing device. As shown in FIG. 8, various compelling sound and visual effects may be heard and seen by the player upon carrying out the predetermined action to uncover the secret layer 202 underlying the promotional layer 108 of the present email ticket 100. One possible such visual effect is the apparent swirling of the promotional layer 108 to reveal the underlying secret layer 202. Reference numeral 802 shows a partially “swirled” promotional layer 108 and reference numeral 802′ shows an almost fully visible secret layer 202. Such a progressive rendering of the underlying secret layer 202 is believed to heighten player interest in the game and may encourage repeat participation. The predetermined action, in this case, may be the player twirling or moving his or her pointing device over the promotional layer 108 until the secret layer 202 is fully visible. Those of skill in the graphic and gaming arts, however, will undoubtedly design other sensorial effects to accompany the gradual or instantaneous uncovering of the secret layer 202, and all such effects are believed to fall within the scope of the present invention. Indeed, amazing animated and interactive graphics effects are currently rendered using, for example, standard Java software, and that future software will bring these special effects even further. Therefore, the method and email tickets described herein are not limited to the rendering capabilities of the current generation of email software. Future technology may be such that any kind of sensory techniques will be emailed such as natural audio, synthesized audio, 3D sounds, 3D vision, vibrations, motion feedback, odor transducers, hot/cold transducers, etc . . . and rendered on a personal computer and/or other computing device or mobile device such that games can be created on the same principles of a combination of a promotional layer 108 and a secret layer that reveals secret symbols which may be correlated to a prize matrix. Alternative interactive techniques to scratching to progressively reveal secret symbols may be based on image panning, image spinning, puzzle effects, kaleidoscope effects, fluid effects, image noise effects, image filtering effects, explosion/implosion effects, and in a more general fashion, any interactive electronic imaging with or without audio effects.

For example, a secret voice message may be scrambled initially and then caused to become progressively become clearer as the email recipient performs a given player interaction, until the statement “You won 100,000 dollars!” (for example) or other promotional message is clearly heard. Audio scrambling may be carried out by mixing the message with other audio sources using various amplitude ratios, spectral editing, reversal of stream, mixing up of audio fragments, or any other analog or digital audio editing technique.

The player may choose to make use of advanced display graphics rendering capabilities such as Macromedia Flash, Macromedia Shockwave, DirectX, etc . . . . These graphics renderers may require the player to install additional software (plug-ins) or to download special software identified by the email ticket provider. In order to effectively reach a large audience, such additional software should be simple to download and to install and should preferably incorporate a proof of origin mechanism such as code assigned by a certification authority and incorporate the necessary mechanisms to prevent virus infection. Scratching or similar effects to progressively reveal secret symbols may be based on multidimensional objects that can be rendered on the email recipient's computer and/or other computing device, including wireless devices such as mobile phones.

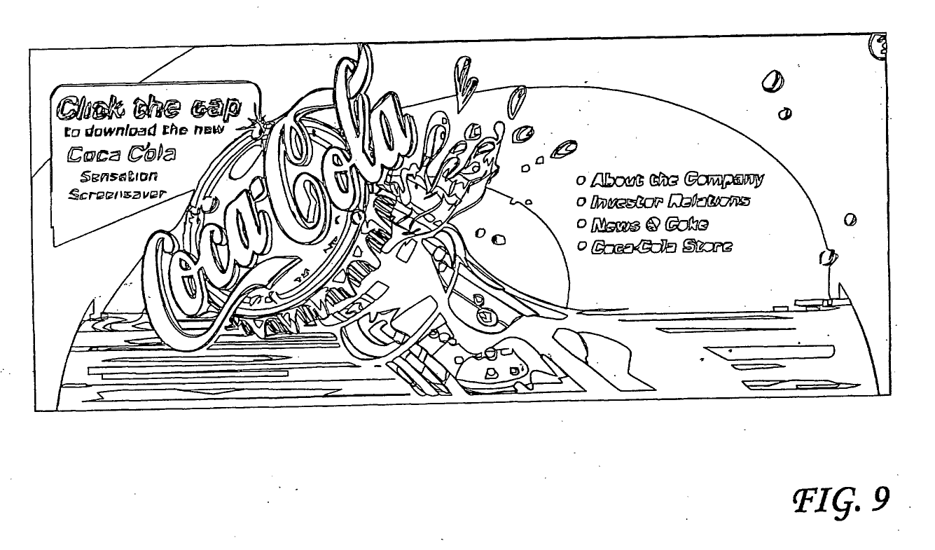

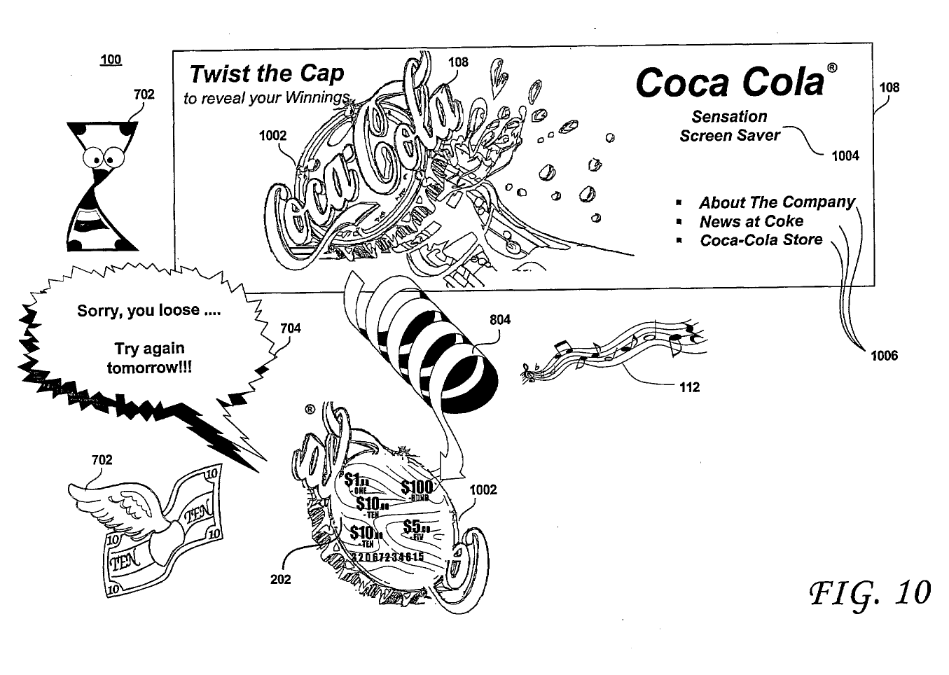

FIG. 9 is a detail view of another embodiment of an email ticket 100 according to the present invention, in which the player is invited to virtually “twist” the bottle cap off to download some file, image or software program, such as a screensaver, for example. FIG. 10 is a diagram of a non-rectangular promotional layer 108 of an email ticket according to still another embodiment of the present invention. In FIG. 10, the player is invited to click on and twirl (as shown at 804) the promotional layer 108 (shaped in FIG. 10 as a corporate logo and/or a bottle cap), with accompanying animation 702 and sound effects 704, 112. The email ticket 100 may also feature hyperlinks 1004, 1006 to download promotional items, or to learn about the company, obtain news or shop at an online store, for example.

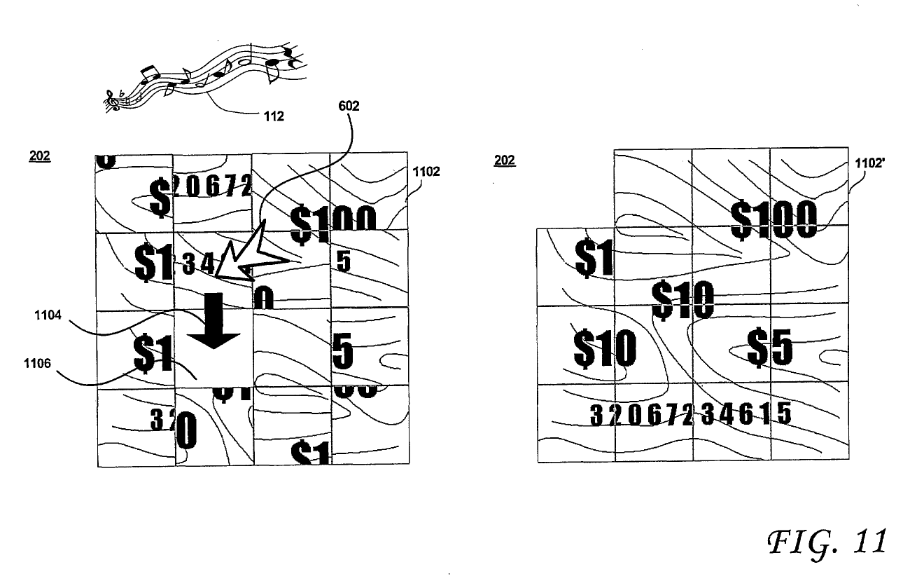

FIG. 11 is a diagram of a secret layer 202 of an email ticket according to an embodiment of the present invention, with a sliding block puzzle 1102, 1202′ and sound effects 112. As shown therein, the secret layer may be revealed following some player action, but need not be immediately revealed in an intelligible or readily understandable manner. Indeed, as shown in FIG. 11, the secret layer 202 may be configured as a sliding block puzzle 1102. When the player moves the onscreen cursor 602 over a block, the block may be configured to automatically slide, as shown at 1104, to the next available space, as shown at 1104. When the player solves the puzzle by properly aligning the constituent blocks of the secret layer 202, as shown at 1102′, the player's winnings (if any) may be revealed, perhaps accompanied with sound effect, music 112 or an announcement, as shown in FIG. 7 at 704. Similarly, FIG. 12 is a diagram of a secret layer 202 of an email ticket according to another embodiment of the present invention, with a jigsaw puzzle 1204, 1204′ and sound effects 112. The player, as shown in FIG. 12, may move his or her cursor 602 over one of the plurality of jigsaw pieces constituting the puzzle 1204, click to select a piece and move the selected jigsaw piece to a selected location, as suggested by arrow 1202 until the completed and solved puzzle 1204′ is shown and the symbol set of he secret layer 202 revealed. Additional or alternative embodiments may suggest themselves to those of skill in this art, and all such additional or alternative embodiments are believed to fall within the scope of the present invention.

However configured, the promotional layer 108 and the secret layer 202 are combined in an email ticket in such a way that the secret layer 202 is initially hidden under a promotional layer 108, and then the symbol set on the secret layer 202 are revealed following some exciting interactive operations and/or a predetermined time-out.

Indeed, according to the present invention, each email ticket is preferably individually identified by a unique secret layer serial number and this unique secret layer serial number may be stored with the random placement index along with the combination of symbols assigned to the secret layer for that particular email. This enables a checking mechanism to check whether a prize claimant is legitimate, whereby the combination of symbols appearing on the secret layer of each email may be matched with the unique secret layer serial number for that email stored along with the random placement index, among other possible validation procedures. If there is a correlation, the prize claimant is legitimate and the prize may be disbursed.

The email ticket may include a readable verification code or authentication information displayed in plain text or displayed as a bitmap that may be masked as part as the prizes claim procedure. The authentication information may be (at least initially) encrypted or scrambled. The authentication information may be visible initially, progressively or upon the email recipient completing a predetermined action on the promotional layer, secret layer and/or anywhere on the email ticket after being decrypted or descrambled by appropriate secure means. The authentication information may be encrypted or scrambled using standard encryption or scrambling techniques (using data strings such as ASCII or similar code(s)). The email ticket may further include a hyperlink that the email recipient may activate to access to an Internet page where further information may be found. Alternatively, the email ticket may include a link that the email recipient may activate to automatically generate an email ticket that requests further information.

According to an embodiment of the present invention, to help insure that the winning secret layers are not compromised, a first party (the email ticket supplier) may prepare the emails and a second party (the email ticket distributor) separate from the first party may send the email. In turn, the first and second parties may each be different from a third party (the email ticket validator) that validates the authenticity of potentially winning emails presented for payment by prize claimants.

Email Ticket Preparation

To avoid fraud, security should be a prime concern in the process of preparing the email tickets according to the present invention. A preferred method of making the email tickets according to the present invention is to prepare an electronic batch of secret layers in advance then combine promotional layers 108 and secret layers 202 at the moment the email tickets are prepared. The batch of secret layers 202 may be kept on any electronic form that allows storage and retrieval of indexed objects. The batch of secret layers 202 preferably contains information that prevents malicious parties from easily finding winning tickets.

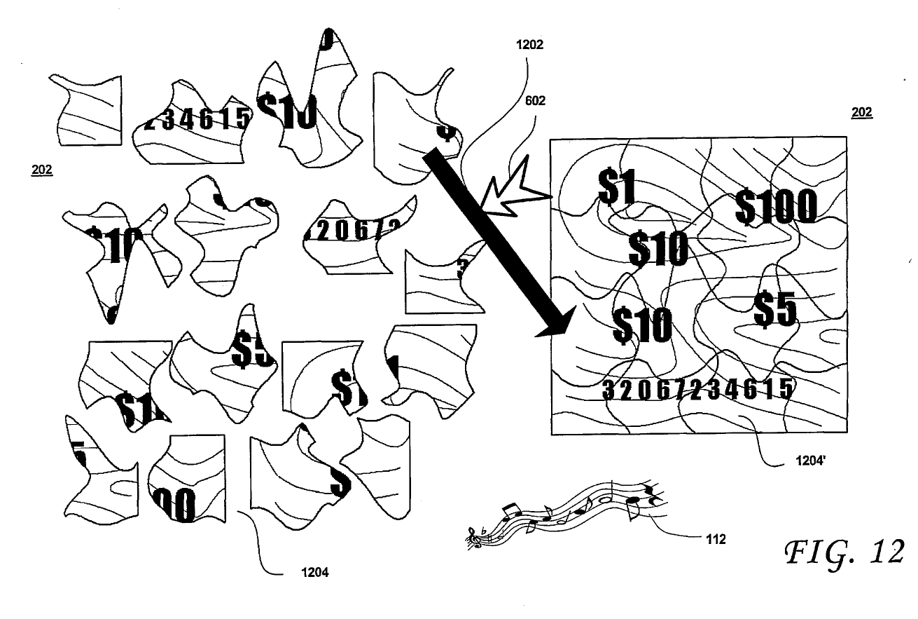

As shown in FIG. 13, the email ticket supplier at S131 may generate a first batch comprising a predetermined number of promotional layers 108 and a second batch comprising a like number of secret layers 202, as shown at S132. The email ticket supplier may then, as shown at S133, combine the promotional and secret layers 202 (and optionally other materials such as a greeting message, hyperlinks, etc.) to generate each email ticket. The ticket supplier may then send the generated batch of emails to the email ticket distributor, who sends the emails to the intended recipients thereof, as shown at S134.

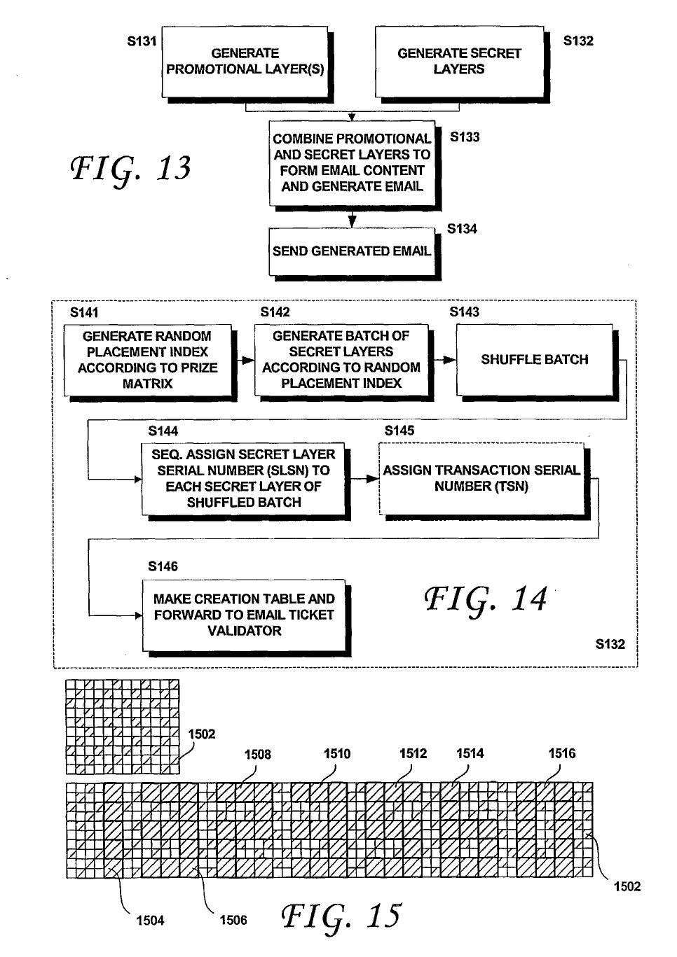

FIG. 14 illustrates further aspects of the present invention. In particular, FIG. 14 shows steps that may be taken to carry out step S132 of FIG. 13; that is, to generate the batch of secret layers 202. Each secret layer 202 according to the present invention is assigned a Secret Layer Serial Number (SLSN), which uniquely identifies each secret layer from among all other secret layer 202 from all email tickets of the current batch or among all email tickets prepared during a predetermined time period (such as, for example, one year). The SLSN may include any combination numbers, letters and/or characters and may be rendered on the secret layer in clear text, using vector imaging or in a bitmap (a matrix of pixels), for example. As shown therein, step S141 calls for the generation of a random placement index according to the prize matrix (See Table 1). The random placement index enables the ticket supplier to place symbol sets at random within the batch of secret layers 202 while complying with distribution of winning symbols defined by the prize matrix. Both the random placement index and the batch of secret layers 202 may be individually encrypted. Preferably, the random placement index is kept secret by the party having prepared the batch of secret layers 202 (the ticket supplier) while the batch of secret layers 202 itself may be forwarded to the party that will carry out the emailing (the ticket distributor). In this manner, the random placement index may be used during claim process and may be forwarded to the ticket validator for their use during the validation process of potentially winning emails of prize claimants. The ticket supplier, as shown at S142, may generate the batch of secret layers 202 according to the previously generated random placement index. For example, in a batch of 1 million email tickets, the random placement index and the prize matrix might dictate that the “3 Eagles” symbol set be placed on a single secret layer numbered 560,435, the “3 Tigers” symbol set be placed on two secret layers, numbered 238,987 and 870,325. Step S143 calls for the batch of secret layers be randomized (i.e., shuffled). Indeed, the shuffling of the secret layers may be carried out to prevent a malicious person from observing the preparation of the batch or flow of secret layers and easily finding the location of the secret layers bearing the winning symbol sets within the batch of secret layers. After or concurrently with the shuffling, a Sequence Number (SN) may be generated for and assigned to each of the secret layers 202, as shown at S144. The SN is a number (or any combination of numbers, letters and/or other characters) assigned to each secret layer 202, and represents the sequential position of the secret layer within the batch of secret layers, after the batch of secret layers has been randomized in step S143.

As shown in FIG. 15, a preferred method, according to the present invention, is to graphically render the symbol set of the secret layer onto a single rectangular (for example) bitmap (for example) graphic layer, optionally together with the unique SLSN and/or other such authentication or verification information. As shown in FIG. 15, the unique SLSN is 1323560, as indicated by the reference numerals 1504-1516, respectively. The SLSN may be set against a random unobtrusive bitmap (for example) background, as shown at 1502 (also shown in FIG. 3, for example) to render automated software recognition of the verification information and/or the symbol set more difficult. A bitmap compression algorithm such as JPEG (Joint Photographic Experts Group, formally ISO standard 10918. JPEG includes currently 29 distinct coding compression algorithms and is commonly supported by standard email software) may then be applied to the secret layer bearing the symbol set and the SLSN and/or other authentication information. As the SLSN is rendered on the secret layer 202 as a bitmapped matrix of pixels, the player can immediately see and understand both the revealed symbol set as well as the SLSN. However, an automated software spy program would have to render the image in its memory using JPEG decompression, then launch a smart Optical Character Recognition (OCR) agent to determine out what the SLSN and/or the symbol sets are. This process is believed to be extremely process intensive and a malicious party would need considerable computer resources to surreptitiously examine large quantities of email tickets is order to extract the SLSN and figure how to profit therefrom. The SLSN and/or any other authentication information may alternatively be scrambled or encrypted by conventional data string (ASCII, for example and/or other code(s)) encryption or scrambling techniques and suitably decrypted or descrambled using secure means during the validation process. Optionally, the email ticket may be digitally signed by a certified, thereby ensuring proof of origin and unmodified content and/or virus free code.

Using a bitmap compression algorithm such as JPEG also endows each secret layer 202 with a unique binary signature. This unique binary signature may also be used during the cross-referencing of email information that occurs when a prize claimant presents a potentially winning email to collect his or her prize. The random unobtrusive background 1502 shown in FIG. 15 may be composed of small dots, small stars, small symbols, fine waving lines as found on banknotes or any other non obtrusive patterns. Color may also be advantageously used to produce a unique binary signature. Other scrambling or encryption techniques can be applied in a similar fashion, depending on the software decryption capabilities available to the player. Color may be advantageously used to produce excitement during the revealing of the hidden symbols. For example, the top prize may be awarded to the email recipient whose secret layer reveals 4 basic shapes of a card game, such as spade, ace, heart and diamond, but with the added constraint that the spade shape must be in black, the ace shape in blue, the diamond shape in green and the heart shape in red.

Email tickets, according to the present invention, may include a greeting message, a promotional layer 108, a secret layer that includes a SLSN, a Transaction Serial Number (TSN), hyperlinks for obtaining additional information and the necessary executable code to enable player interaction, special animation effects and audio effects, are sent to the subscribers of the mailing list. The TSN is a number and/or sequence of numbers, letters and/or other characters that is sequentially assigned to each email ticket and represents the order in which the email ticket is created and/or sent. The TSN, as shown at S145 in FIG. 14, may be generated by the email ticket supplier. From these and as shown at S146, the email ticket supplier may prepare an creation table that may list, for each prepared email ticket, the symbol set appearing on the secret layer for that email ticket, the winning amount for that secret layer, the SLSN and the SN. The batch of prepared email tickets may then be sent to the email ticket distributor for dispatching to the intended email ticket recipients. The creation table is preferably kept secret and sent to the ticket validator, who may use the creation table, together with other tables and/or indexes to validate the authenticity of potentially winning email tickets.

Email Ticket Dispatch

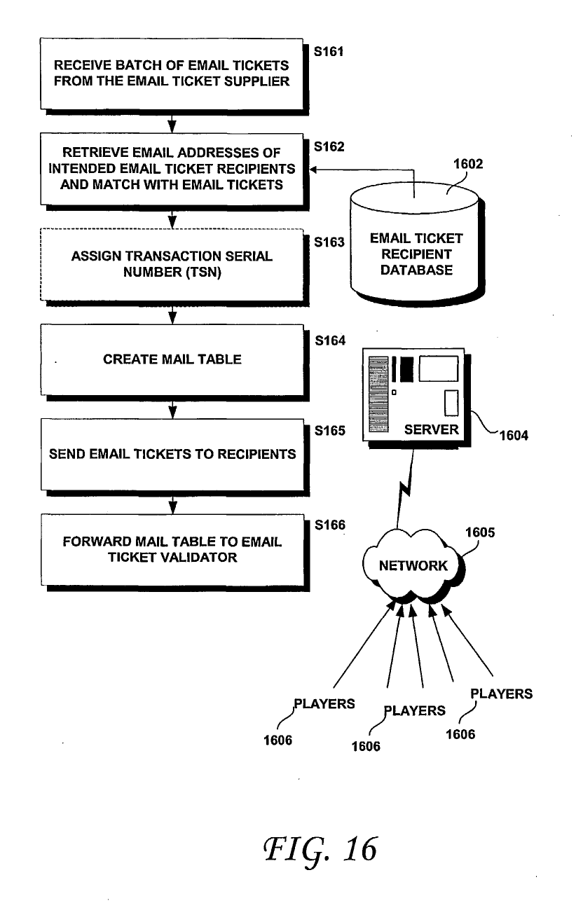

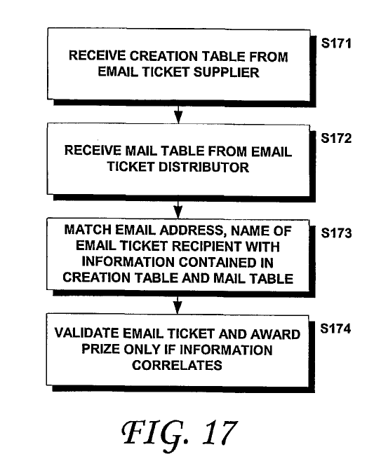

FIG. 16 shows steps that may be taken by an email ticket distributor to send the email tickets to the intended email ticket recipients, according to an embodiment of the present invention. As shown at S161, the email ticket distributor receives the batch of prepared email tickets from the email ticket supplier. The email ticket supplier may then retrieve the email addresses of the intended email ticket recipients from a database 1602 of registered players and matches the retrieved email addresses with the email tickets of the received batch, as shown at S162. According to an embodiment of the present invention, players 1606 may register on-line over the network 1605 (which may include the Internet, for example) with an Internet electronic gaming provider server 1604 by supplying the provider with personal information such as name, mailing address, email address and/or payment details, which information may then be entered into the database 1602. Payment details may not be necessary when registering and playing with free gaming organizations. If not previously created by the email ticket supplier, a Transaction Serial Number (TSN) is assigned to each email in step S163, which TSN corresponds to the order in which each email ticket will be sent to its intended recipient. A mail table may then be created as shown at S164, which mail table lists, for each email ticket, the TSN, the SN of the secret layer of the email ticket and the email address to which the email ticket has or will be sent. The batch of email tickets may then, as shown at S165, be sent to the intended recipients thereof. The email ticket distributor has no knowledge of the distribution of the winning email tickets (the email tickets that include a secret layer bearing a symbol set that corresponds to a prize, as specified in the prize matrix). The email mail table may then be used during the validation procedure of potentially winning email tickets. The mail table may then be forwarded to the ticket validator for just such purpose, as shown at S166.

Email Ticket Validation

FIG. 17 shows steps that may be taken by an email ticket validator to validate the authenticity of potentially winning email tickets presented by prize claimants. As shown at steps S171 and S172, the email ticket validator receives the creation table from the email ticket supplier and the mail table from the email ticket distributor. From at least the creation table and the mail table, the email ticket validator has all the necessary information to validate the authenticity of a potentially winning email ticket presented for payment by a prize claimant. Indeed, as shown at S173, the email ticket validator may check the successful correlation between (a) the information supplied by the claiming party, such as name and email address, the symbol set, the amount or value of the prize for that symbol set, the revealed SLSN of the secret layer for that email ticket, the SN assigned to that secret layer and the TSN for the email ticket. The SLSN and the TSN may appear on the email ticket itself, as shown in FIG. 2 in which the SLSN is shown at reference numeral 1702 and the TSN is shown at reference numeral 1704. The SLSN 1702 and the TSN 1704 on the email ticket 100 may or may not be perceptible to the player. Color may be used to readily distinguish between the two numbers and to provide another means of authentication of valid email tickets. The random placement index generated when the secret layers were generated may also be correlated with the above-listed information, such as the SLSN. It is a common policy that the prizes are only awarded to legitimate registered players in accordance with the provider's rules. Such rules usually include governing laws, under age policy, and proof of identification procedure to claim prizes. The email ticket validator, therefore, may verify compliance with such rules, such as expiration period, proof of age, identity and address, and the like. If the above-listed information all point to the same email ticket, the prize corresponding to the symbol set appearing on the winning email ticket presented for payment may be awarded, as shown at S174.

According to the present invention, players may receive a message by email containing information that is rendered differently depending on their email viewing capability. There are 3 classes of viewing capabilities available in currently available email software: plain text, rich content and Hypertext Markup Language (HTML—including Dynamic HTML) content. If the email software (email client or browser, for example) is only capable of viewing plain text information, then the player may see two sections; namely, a first section that may be expressed in the natural human language and that is readily understandable, and a second section that may be expressed in a mixture of programming code, imaging code and cryptographic code. Within the first section, there may be some text inviting the player to ignore the second section In the text of the first section, the player will be invited to follow a predetermined hyperlink to a page on the Internet to view the electronic email ticket in his or her Internet browser.

If the email recipient's email software is capable of viewing rich content, the player may see three sections: a first section that may be expressed in the natural human language and that may be readily understandable, a second section that may show a graphic representation of a so-called “virgin” email ticket and a third section that is expressed in a mixture of programming code, imaging code and cryptographic code. The first section may include text inviting the player to ignore the third section. The graphic representation of a “virgin” email ticket does not allow the player to scratch the ticket. In the text of the first section, the player may be invited to click anywhere on or at some designated place on the email ticket displayed in order to follow a predetermined link to a page on the Internet to view the electronic email ticket within his or her Internet browser and to perform the scratch-off of the promotional layer or to carry out some other predetermined interaction.

If the email software is capable of rendering HTML code and of executing executable embedded code, the player may see a graphic representation of a “virgin” email ticket, as shown at FIG. 1. There may be some human readable text printed on the ticket itself, or outside inviting the player to electronically scratch the email ticket by dragging the cursor 602 over the promotional layer 108 using an interactive device such as a mouse, touch pad or equivalent, the keyboard, a stylet or a finger in case of touch screen devices. While being dragged over in a way similar to scratching, the promotional layer 108 may progressively reveal the secret layer that displays the secret and initially hidden symbol set, as described in detail above. Scratching sounds and/or other sound effects may be generated while performing the electronic scratching operation.

While the foregoing detailed description has described preferred embodiments of the present invention, it is to be understood that the above description is illustrative only and not limiting of the disclosed invention. Modifications may occur to those of skill in this art. Thus, the present invention to be limited only by the claims as set forth below.

1. An email ticket that provides an email ticket recipient an opportunity to win a prize, comprising:
a secret layer, the secret layer being configured to be initially hidden from view and gradually revealed following a predetermined action by the email recipient, the secret layer including a representation of a symbol set, the symbol set including one of a plurality of combinations of selected symbols,
a promotional layer, the promotional layer being configured to initially obscure the secret layer and to progressively reveal at least a portion of the secret layer following the predetermined action by the email recipient, at least one of the secret layer, the email ticket and the promotional layer including authentication information that enables authentication of a potentially winning email ticket.

2. The email ticket of claim 1, wherein the authentication information is graphically rendered on the secret layer, the promotional layer or the email ticket.

3. The email ticket of claim 1, wherein the authentication information is human readable and is displayed at a predetermined location on the email ticket.

4. The email ticket of claim 3, wherein the authentication information is displayed on the email ticket initially, progressively or following the predetermined user action.

5. The email ticket of claim 1, wherein the authentication information is encrypted or scrambled.

6. The email ticket of claim 1, wherein the authentication information is visible only after having been decrypted or descrambled using secure means.

7. The email ticket of claim 1, wherein the authentication information includes a secret layer serial number uniquely identifying the secret layer.

8. The email ticket of claim 1, wherein the authentication information includes a secret layer serial number uniquely identifying the secret layer and at least one of the promotional layer and the secret layer includes a transaction serial number indicating an order in which the email ticket was at least one of created and mailed to the email recipient.

9. The email ticket of claim 1, wherein the secret layer is associated with a secret layer sequence number, the secret layer sequence number denoting a sequential position of the secret layer within a batch of secret layers after an order of constituent secret layers of the batch has been randomized.

10. The email ticket of claim 1, wherein the authentication information is rendered as a bitmap graphic.

11. The email ticket of claim 10, wherein the authentication information includes color.

12. The email ticket of claim 1, wherein the representation of the symbol set is rendered as a bitmap graphic.

13. The email ticket of claim 1, wherein the secret layer is non-rectangular in shape.

14. The email ticket of claim 13, wherein the promotional layer overlies the secret layer and has a shape that matches the shape of the secret layer.

15. The email ticket of claim 1, wherein the promotional layer is shaped as a corporate logo.

16. The email ticket of claim 1, wherein the promotional layer includes a corporate logo.

17. The email ticket of claim 1, wherein the promotional layer includes a hyperlink.

18. The email ticket of claim 17, wherein the hyperlink is an Internet hyperlink configured to enable the email recipient to download and install software.

19. The email ticket of claim 17, wherein the hyperlink is a hyperlink to an Internet page that may be activated by the email recipient.

20. The email ticket of claim 17, wherein the hyperlink is configured to enable the email recipient to automatically generate an email to obtain further information.

21. The email ticket of claim 1, wherein at least one of the promotional layer and the secret layer is configured as a puzzle.

22. The email ticket of claim 21, wherein the secret layer is configured as a puzzle and wherein the representation of the symbol set is unintelligible until the puzzle is solved.

23. The email ticket of claim 22, wherein the puzzle includes a jigsaw puzzle.

24. The email ticket of claim 22, wherein the puzzle includes a sliding block puzzle.

25. The email ticket of claim 1, wherein the email ticket is configured to cause a sound effect to be selectively played.

26. The email ticket of claim 25, wherein the sound effect includes music.

27. The email ticket of claim 25, wherein the sound effect includes a human voice announcement.

28. The email ticket of claim 27, wherein the human voice explicitly informs the email recipient that he or she has won a prize.

29. The email ticket of claim 25, wherein the sound effect includes a scratching sound.

30. The email ticket of claim 1, wherein the predetermined action includes a twirling action of a pointing device and wherein the email ticket is configured to swirl away to progressively reveal at least a portion of the secret layer.

31. The email ticket of claim 1, wherein the promotional layer is configured to reveal at least a portion of the secret layer after a predetermined timeout when the email ticket recipient does not carry out the predetermined action.

32. The email ticket of claim 1, wherein the email ticket is configured to generate a scrambled audio message, and wherein the email ticket is further configured to progressively transform the scrambled audio message into a clear intelligible audio message during the predetermined action by the email ticket recipient.

33. The email ticket of claim 1, wherein the email ticket is configured to generate a scrambled audio message, and wherein the email ticket is further configured to progressively replace the scrambled audio message with a clear intelligible audio message during the predetermined action by the email ticket recipient.

34. The email ticket of claim 1, the email ticket is configured to generate a scrambled audio message and a visual message, wherein the email ticket is further configured to progressively replace the scrambled audio message with or transform the scrambled audio message into a clear intelligible audio message and to progressively reveal the visual message during the predetermined action by the email ticket recipient.

35. The email ticket of claim 1, wherein the graphically rendered authentication information is configured as a bitmap resulting from a bitmap compression of a bitmap rendering of the symbol set.

36. The email ticket of claim 1, wherein the graphically rendered authentication information is configured as a bitmap resulting from a bitmap compression of a bitmap rendering of the symbol set and of a bitmap rendering of a serial number of the secret layer.

37. The email ticket of claim 1, wherein the graphically rendered authentication information is configured as a bitmap resulting from a bitmap compression of a bitmap rendering of the symbol set, of a bitmap rendering of a serial number of the secret layer and of a bitmap rendering of a random pattern.

38. The email ticket of claim 1, wherein the graphically rendered authentication information is configured as a bitmap resulting from a bitmap compression of a bitmap rendering of a serial number of the secret layer.

39. The email ticket of claim 1, wherein the graphically rendered authentication information is configured as a bitmap resulting from a JPEG compression of the bitmap rendering of the representation of the symbol set.

40. The email ticket of claim 1, wherein the graphically rendered authentication information is configured as a bitmap resulting from a JPEG compression of the bitmap rendering of the representation of the symbol set and of a bitmap rendering of a serial number of the secret layer.

41. The email ticket of claim 1, wherein the graphically rendered authentication information is configured as a bitmap resulting from a JPEG compression of a bitmap rendering of a serial number of the secret layer.

42. The email ticket of claim 1, wherein the graphically rendered authentication information is configured as a bitmap resulting from a JPEG compression of a merging of a bitmap rendering of the representation of the symbol set, of a bitmap rendering of a serial number and of a bitmap rendering of an random pattern.

43. The email ticket of claim 1, wherein the graphically rendered authentication information is configured as a bitmap results from an encryption of a bitmap rendering of the representation of the symbol set.

44. The email ticket of claim 1, wherein the graphically rendered authentication information is configured as a bitmap resulting from an encryption of a merging of a bitmap rendering of the representation of the symbol set and of a bitmap rendering of a serial number.

45. The email ticket of claim 1, wherein the graphically rendered authentication information is configured as a bitmap resulting from an encryption of a merging of a bitmap rendering of the representation of the symbol set, of a bitmap rendering of a serial number and of a bitmap rendering of a random pattern.

46. The email ticket of claim 1, wherein the email ticket is digitally signed by a certified authority.

47. The email ticket of claim 17, wherein the authentication information comprises a readable verification code displayed in one of plain text and as a bitmap.

48. A computer system configured to distribute a batch of email tickets that provide email ticket recipients an opportunity to win a prize, comprising:
at least one processor;
a plurality of processes spawned by said at least one processor, the processes including processing logic for sending a batch of email tickets to selected email ticket recipients, each email ticket of the batch including:
a secret layer, the secret layer being configured to be initially hidden from view and gradually revealed following a predetermined action by the email recipient, the secret layer including a representation of a symbol set, the symbol set including one of a plurality of combinations of selected symbols, and
a promotional layer, the promotional layer being configured to initially obscure the secret layer and to progressively reveal at least a portion of the secret layer following the predetermined user action, at least one of the secret layer and the promotional layer including human readable authentication information that enables secure authentication of a potentially winning email ticket.

49. The computer system of claim 48, wherein the selected email recipients are stored in a database accessible to the computer system.

50. The computer system of claim 49, wherein the computer system is coupled to a network accessible to potential players and wherein the computer system is further configured to enable the potential players to register to receive the email tickets over the network.

51. The computer system of claim 50, wherein the network includes the Internet.
